(19) United States
(12) Patent Application Publication
(10) Pub. No.: US 2025/0074809 A1
(43) Pub. Date: Mar. 6, 2025

(54) CONTROLLED COOLING APPARATUS AND METHODS PROVIDING PREFERENTIAL COOLING OR HEATING WITHIN A CONTINUOUS GLASS RIBBON

(71) Applicant: CORNING INCORPORATED, CORNING, NY (US)

(72) Inventors: MAOPEI CUI, PAINTED POST, NY (US); STEPHEN RAY HOWARD, LAWRENCEBURG, KY (US); JUI-HSIANG HUNG, PINE BROOK, NJ (US); MARK DAVID MCCARTY, CORNING, NY (US); ROHIT RAI, PAINTED POST, NY (US)

(21) Appl. No.: 18/724,767

(22) PCT Filed: Dec. 5, 2022
(86) PCT No.: PCT/US2022/051791

§ 371 Date: Jun. 27, 2024

Related U.S. Application Data
(60) Provisional application No. 63/295,137, filed on Dec. 30, 2021.

(51) Int. Cl. C03B 25/08; C03B 29/08

(52) U.S. Cl. CPC C03B 25/08; C03B 29/08

(57) ABSTRACT

A glass ribbon processing apparatus to produce a glass ribbon with variable thickness includes a first device that cools a first portion of a width of the glass ribbon at a different rate than a second portion of a width of the glass ribbon, wherein the first portion is thicker than the second portion.

### CROSS-REFERENCE TO RELATED APPLICATION

This application claims the benefit of priority under 35 U.S.C. § 119 of U.S. Provisional Application Ser. No. 63/295,137 filed on Dec. 30, 2021, the content of which is relied upon and incorporated herein by reference in its entirety.

### BACKGROUND

### 1. Field of the Disclosure

The present disclosure relates to a controlled cooling apparatus and methods providing preferential cooling or heating within a continuous glass ribbon. The apparatus and methods disclosed can be provided as a modification to existing glass processing or used in new designs to produce glass products.

### 2. Description of the Related Art

Back covers for certain smartphones and mobile devices or any glass body for an electronic component or enclosure design that have a non-uniform thickness, the non-uniform thickness being thicker in the camera region than the other portions, allow for improved camera lens designs (see, for example U.S. PG Pub. 2019/0364179 A1). As an example, the glass thickness can be 1.5-3.0 mm in thicker portions and <0.8 mm elsewhere. To fabricate the thicker section for the device back-cover or enclosure, a relatively thick glass sheet can be ground, lapped, and polished to define a thicker area and a thinner area. In such a case, to make a glass article with a 1.6 mm thickness in the thicker region and a 0.6 mm nominal thickness elsewhere, a glass sheet with a 1.9 mm thickness can be used. That is, 0.3 mm of material would be removed from the thicker portion and 1.3 mm of material from the thinner portion everywhere else. This approach has poor glass utilization, is time consuming, costly, inefficient, and not environmentally friendly.

In an alternative method of forming glass articles with non-uniform thickness, two glass substrates could be fused together (see, for example U.S. PG Pub. 2017/0210111A1). For example, a 25 mm×25 mm×1.0 mm glass piece can be fused to a larger glass piece of 70 mm×150 mm×0.6 mm piece by bonding or pressing together under high temperatures. This method improves glass utilization but is energy intensive, can result in bubble formation at the fused interface, and can be costly and a more time consuming.

When the grinding process is not cost effective and produces too much waste, and when fusing two glass pieces together is not a viable option, another solution is to define a continuous glass ribbon having the desired thickness differences. Producing a glass ribbon with a variation in thickness can require generating a significant difference in temperatures between the thicker portion and the thinner portion. To manufacture such a glass ribbon with low stress and warp, therefore, requires the ability to preferentially cool the thicker portion at a prescribed rate that is different from the cooling rate of the base ribbon (or the thinner portion of the glass ribbon).

The present disclosure provides solutions to this technical challenge.

### SUMMARY

To overcome the problems described above, embodiments of the present disclosure provide apparatus and methods that minimize stress and warp in variable thickness glass sheets by cooling a thicker portion of a glass ribbon at a higher rate than cooling a thinner portion by managing thick-to-thin and top-to-bottom temperature gradients. The cooling can be performed through convection and/or radiation, and from top and/or bottom of the glass ribbon. Optionally, localized heating can be used along with preferential cooling to control the desired temperature parameters within the glass.

The embodiments described can be applied to a controlled cooling apparatus (CCA). The CCA is a modified lehr, or a roller hearth lehr, or a roller kiln that produces glass ribbons. The present disclosure provides solutions to the thermal management challenges that must be overcome to produce a glass ribbon with variable thicknesses.

Without the thermal management methods presently described, stresses generated in glass ribbons with variable thicknesses will be too high. Such would require scoring sheets, cutting high-stress portions out of sheets, or providing extra finishing processes to produce glass to the desired size, shape, and thicknesses. Alternative methods to reduce stresses in glass ribbons would be to significantly increase the lehr length or adding an annealing step. Both of these methods involve significant cost and space requirements.

According to an embodiment of the present disclosure, a glass ribbon processing apparatus to produce a glass ribbon with variable thickness includes a first device that cools a first portion of a width of the glass ribbon at a different rate than a second portion of a width of the glass ribbon, wherein the first portion is thicker than the second portion.

In an embodiment, the first device is located above or below and approximate to the glass ribbon. In an embodiment, the first device is a heat exchanger that extracts heat from the first portion. In an embodiment, the first device forces air onto the first portion. In an embodiment, the first device is configured to extract heat from the first portion and force air onto the first portion. In an embodiment, the first device includes a valve to adjust the air forced onto the first portion. In an embodiment, the first device includes a heater.

The glass ribbon processing apparatus can further include a second device that heats any portion of a width of the glass ribbon.

In an embodiment, the second device heats an interface of the first portion and the second portion.

In an embodiment, the first device is a plurality of first devices that are configured to be positionally adjusted within the apparatus.

The glass ribbon processing apparatus can further include a sectional heater that includes at least two heating zones to provide heat treatment to the glass ribbon.

According to an embodiment of the present disclosure, a method of producing a glass ribbon with variable thickness includes conveying the glass ribbon; and cooling a first portion of a width of the glass ribbon at a different rate than a second portion of a width of the glass ribbon, wherein the first portion is thicker than the second portion.

In the method, the cooling is provided by a device that is located above or below and approximate to the glass ribbon. In an embodiment, the cooling is provided by a heat exchanger that extracts heat from the first portion. In an embodiment, the cooling is from air forced onto the first portion.

In the method, the first device is configured to extract heat from the first portion and force air onto the first portion. In the method, the first device heats the glass ribbon.

The method can further include heating an interface of the first portion and the second portion.

The method can further include heating the width of the glass ribbon in sections.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1A-1C are examples of glass ribbon geometries.

FIG. 2 is a graph showing baseline cooling curves of a variable thickness glass ribbon.

FIGS. 3A and 3B are glass ribbon cooling curves.

FIG. 4 that is a model of a section of a controlled cooling apparatus.

FIGS. 5A and 5B are images of a controlled cooling apparatus.

FIG. 6 shows cooling flow vs stress and warp data.

FIG. 7 shows a radiation member.

FIG. 8 shows a combination member.

FIG. 9 shows an air box with a strip heater.

FIGS. 10A and 10B are models showing the effects of air flow from an air box.

FIGS. 11A and 11B are diagrams representing the cooling effects to a thicker portion of a glass ribbon.

FIGS. 12-16 are cross sectional representations of different configurations of a controlled cooling apparatus tunnel.

### DETAILED DESCRIPTION

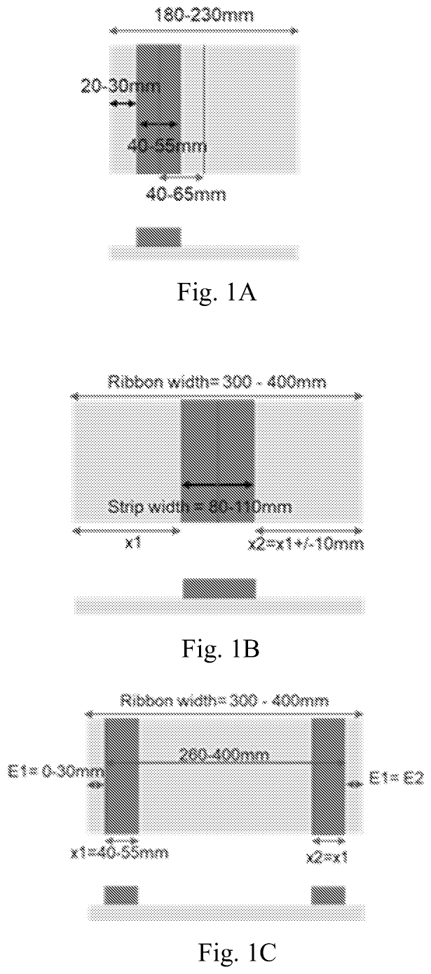

FIGS. 1A-1C are examples of glass ribbon geometries made possible by apparatus and methods described in the present disclosure. The geometries shown are not reflective of all-possible geometries but are instead designed for specific products.

In FIGS. 1A-1C, the lighter blue portion is meant to represent the base ribbon or thinner portion where the darker blue portion represents the thicker portion. FIG. 1A represents a glass ribbon having a total width of between 180-230 mm. The thicker portion is shown having a width of 40-55 mm starting 20-30 mm from the left edge of the glass ribbon with a center that is located 40-65 mm from the center of the glass ribbon.

FIG. 1B represents a glass ribbon having a total width of between 300-400 mm. The thicker portion is shown having a width of 180-110 mm and located about the center of the glass ribbon.

FIG. 1C represents a glass ribbon having a total width of between 300-400 mm. This ribbon includes two thicker portions both having a width of 40-55 mm where one thicker portion is located 0-30 mm from the left edge of the glass ribbon and the other thicker portion is located equidistant from the right edge of the glass ribbon.

TABLE 1

| | Total thickness | Base |
|---|---|---|
| | at strip | thickness |
| 1 | 5.0 mm | 5.0 mm |
| 2 | 3.0 mm | 3.0 mm |
| 3 | 0.6 mm | 0. [symbol] mm |
| 4 | 3.5 mm | 0.9 mm |
| 5 | 2.4 mm | 0.9 mm |

[symbol]

indicates data missing or illegible when filed

Table 1 includes some exemplary parameters to indicate a possible range of thickness values for the thinner and thinner portions of a glass ribbon. Items 1-3 show that a glass ribbon with a totally uniform thickness is also possible.

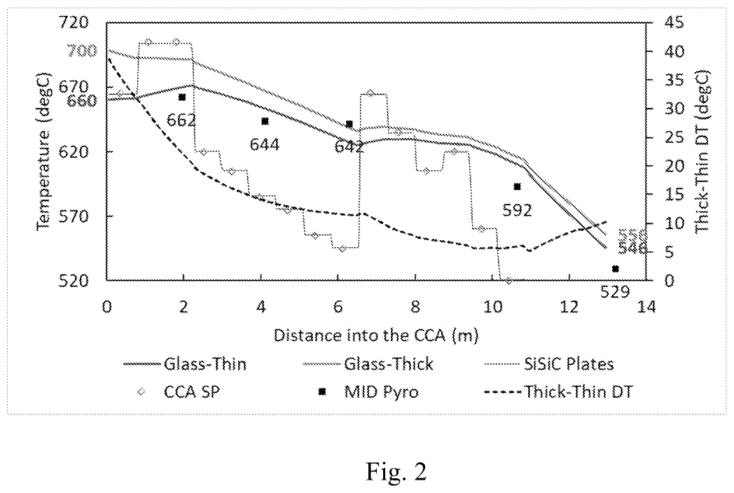

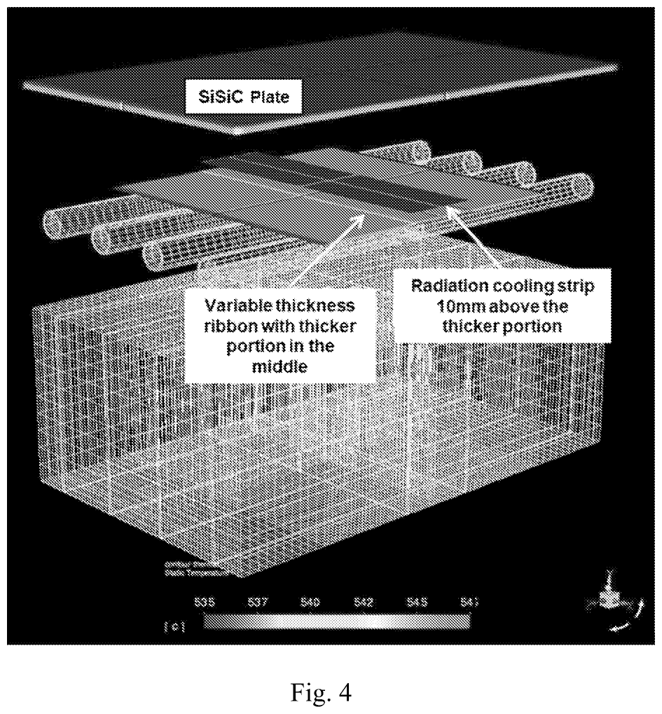

FIG. 2 is a graph showing baseline cooling curves of a variable thickness glass ribbon product with the base glass thickness at 2.0 mm and a center strip with a 0.3 mm delta thickness variation inside a CCA. This cooling curve data was obtained and modeled in an early manufacturing trial for a variable thickness glass ribbon where no preferential thermal management tools or techniques were used inside the CCA. That is, the CCA had a standard equipment setup where only SiSiC plates were used for radiation cooling of the entire glass ribbon. See FIG. 4 that shows a section of a CCA including a SiSiC plate. The SiSiC plate has a low coefficient of thermal expansion (CTE) and a high thermal conductivity and is well suited to provide a uniform source of radiant heating above the glass ribbon in a CCA tunnel.

FIG. 2 plots the glass ribbon temperature along the left vertical axis versus the distance into the CCA tunnel along the horizontal axis in a conventional process. The red curve is a model of the top side (A-side) centerline temperature of the thicker portion. As shown, the temperature of the thicker portion was 700° C. at the entrance of the CCA and 556° C. at the exit of the CCA. The blue curve is a model of the temperature of the thinner base glass. As shown, the temperature of the thinner portion was 660° C. at the entrance of the CCA and 546° C. at the exit of the CCA. The gray diamond shaped data points (CCA SP) represent temperature set points of the SiSiC plates at positions along the CCA tunnel. The gray curve is the temperature of the SiSiC plates through the set points. The black square shaped data points and indicated values are actual pyrometric temperatures of the glass ribbon as measured through the SiSiC plates.

The black dashed line represents a difference in temperature as modeled between the thicker portion and the thinner portion, delta T (DT), of the glass ribbon and is plotted to the right vertical axis. The data revealed an anticipated mismatch of cooling rates between the thicker portion and the thinner base of the glass ribbon.

Conventional thermal management inside the CCA led to the thicker portion being constantly hotter than the thinner base glass throughout the controlled cooling section. This persistent thermal gradient between the thicker and thinner portions present during ribbon cooling, though reasonably well managed by controlling the CCA SP for this low delta thickness product, caused high stress and warp in the as-formed products. There is abundant evidence from the subsequent trials that the thick-to-thin DT would become much worse for even higher delta-thickness products, with more mass in the thicker portion, indicating a pressing need for preferential thermal management tools inside the CCA to lower the thermal gradient and reduce resulting stress.

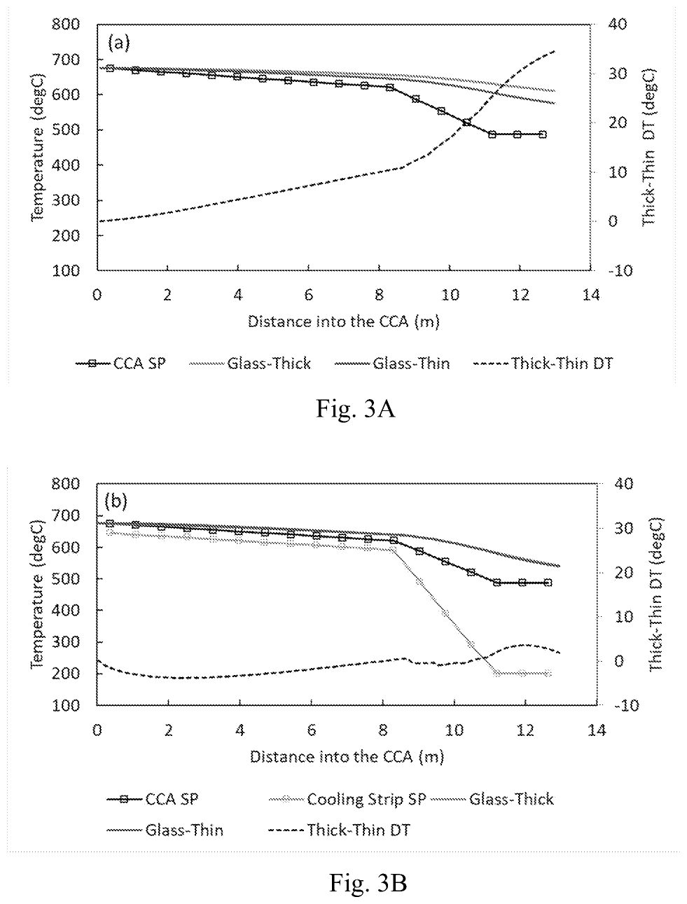

FIGS. 3A and 3B are modeled glass ribbon cooling curves with the glass ribbon temperature along the left vertical axis versus the distance into the CCA along the horizontal axis comparing a process with preferential cooling. The glass ribbon is a center strip product with 1.4 mm delta thickness with the thinner base glass at 1.0 mm thickness. The red curve is the thicker portion centerline temperature and the blue curve is that of the thinner base glass. The solid black cure is the CCA set point temperatures. FIGS. 3A and 3B compare the cooling curves of a same variable thickness product with two different CCA equipment set-ups. FIG. 3A shows results with a conventional CCA equipment without preferential cooling. That is, SiSiC plates are used for controlled radiation heating and cooling of the entire glass ribbon. FIG. 3B shows results with preferential cooling, where an additional radiation cooling strip is located 10 mm above the thicker portion of the glass ribbon for extra cooling. The black dashed curves in both figures plot the thick-to-thin temperature difference (DT) inside the CCA. As shown, the thick-to-thin DT is zero at the CCA entrance in both scenarios.

FIGS. 3A and 3B demonstrate that a process of local preferential cooling inside the CCA is capable of minimizing the thick-to-thin DT, close to zero, throughout the controlled cooling section, where stress and warp are most sensitive to thermal non-uniformity inside the products due to the viscoelastic nature of a cooling glass.

In FIG. 3A, the cooling curves of a 1.4 mm delta thickness glass ribbon product in the controlled cooling section are shown, where the CCA is configured with a conventional equipment setup similar to that used to generate the data plotted in FIG. 2. The different results being attributed to different CCA set points and the differences in DT between the trials. FIG. 3B shows the cooling curves of the same glass ribbon product and the same CCA setup that includes a local radiation cooling strip 10 mm above the thicker portion. Comparing the thick-to-thin DT of the two cases, shown by the black dashed line (value to the secondary y-axis), a clear thermal impact is evident between a process with conventional cooling and that with the local preferential cooling strip.

As shown in FIG. 3A, the thick-to-thin DT is cumulatively increasing from the CCA entrance to the exit due to the thick-to-thin cooling rate mismatch with conventional cooling. As shown in FIG. 3B, using a process with the cooling strip put on top of the thicker portion and the face temperatures optimized relative to the SiSiC plate temperatures, the thick-to-thin DT can be minimized, close to zero, inside the CCA. It should be understood that the in-CCA preferential thermal tools are not limited to using this particular radiation cooling method or to cooling any one side of the glass ribbon. In embodiments, preferential thermal tools can be a combination or single use of convection and/or radiation to the top (A-side) and/or bottom (B-side) sides of the glass ribbon product.

An important factor is that extra cooling is provided via the preferential thermal tools so that the glass ribbon achieves near identical temperatures in the thick and thin portions to maintain the thick-to-thin DT close to zero inside the CCA. One such preferential thermal tool for extra cooling of the thicker portion is modeled in FIG. 4, where the cooling curves, CCA SP, and cooling strip (the green curve) temperatures are shown in FIG. 3B. The preferential cooling of the thicker portion of the glass ribbon can be combined with preferential heating of the thinner portions, particularly in the earlier modules or sections of the CCA if the temperature of the thin portion is lower than predetermined target values. Heating of the thinner portions can be accomplished either by local heating tools or by keeping the overall CCA module temperature higher than the temperature of thinner portions (while the cooling tools preferentially cool the thinner portions).

FIG. 4 is a concept model showing an equipment configuration for preferential cooling inside a CCA. A portion of a variable thickness glass ribbon is shown riding on rollers and uniformly heated from above by radiation from a SiSiC plate. The white lattice structure below the rollers represents thermal insulation to help maintain efficient uniform heating. An actively cooled radiation cooling strip at a uniform temperature is located 10 mm above a centrally located thicker portion of the glass ribbon to provide extra cooling to the thicker portion. The model presents a numerical proof-of-concept that preferential thermal tools can be used to keep thick-to-thin DT at a minimum inside the CCA, which is key to minimizing stress and warp in as-formed products.

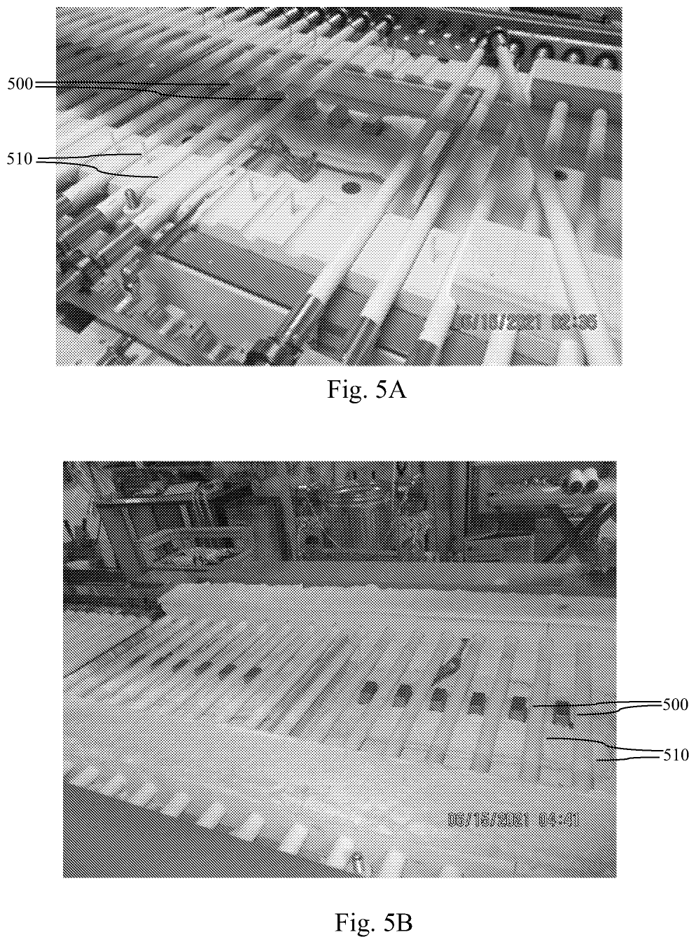

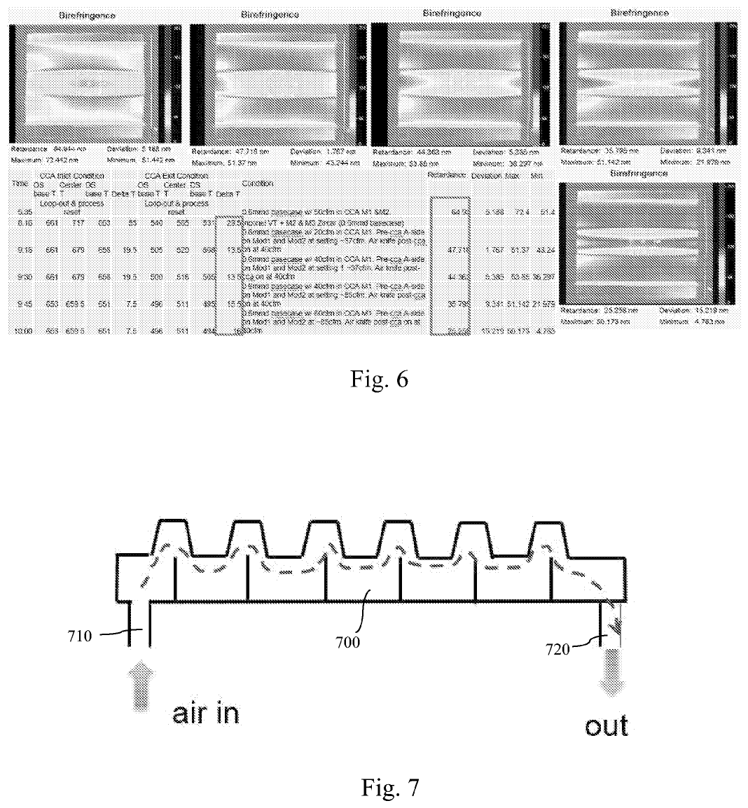

FIGS. 5A and 5B are images of a CCA that has been modified to test the concept of preferentially cooling a thick center region of a continuous glass ribbon by way of forced convection. Air boxes 500 were installed below the rollers 510 as shown in the images such that an array of holes could deliver a stream of coolant air precisely where needed to the underside (B-side) of the glass ribbon. In this case, the boxes could be moved process-left and/or process-right to align them based on feedback provided by birefringence maps as exemplified in FIG. 6. The air delivery available was in a range from 0 (zero) to 35 (thirty-five) scfm and at a velocity of about 30 m/s and from a distance of about 0.5″ off the rear surface of the glass ribbon.

The cooling flow vs stress and warp data in FIG. 6 illustrates that as the thicker portion is cooled such that the temperature difference between the thicker and thinner portions is reduced, the stress in the glass ribbon also goes down. From the data, it is noted that the hole size, hole spacing, coverage area, distance from the ribbon of the air boxes, and other geometric features can be optimized based on the particular application and desired results.

Providing cooling can be done using any combination of forced air (convection) and radiation. Cooling system design includes consideration of factors including emissivity, the ideal gas law and expansion of the heated air, removal of the heated air from the building, and occupant safety. In some applications or temperature ranges where forcing air directly on the glass ribbon is not needed or undesirable, the forced air cooling can be combined with or provided by radiation by removing or entirely eliminating holes from the air boxes as shown in FIG. 7. For example, in the first third of the CCA where temperatures are in excess of 600° C., radiation can be effective at producing a temperature drop while also being less stressful on the glass ribbon whereas in the latter two-thirds of the CCA with temperatures below 600° C. forced convection can be more beneficial.

FIG. 7 shows a design for a radiation member 700 used to cool a side of a glass ribbon. Here, the radiation member 700 includes an inlet 710 and an outlet 720 with no openings to allow air to impinge on the glass ribbon. That is, cooler air enters the inlet 710 travels through a passage and/or across a baffle in the radiation member 700 and exits the outlet 720 at a higher temperature to extract heat from the radiation member 700 that has been absorbed due to its proximity to the hotter glass ribbon. As a heat exchanger, any coolant other than air such as any suitable gas, water, or another suitable liquid can be used to enter the inlet 710 and exit the outlet 720 to remove heat from the radiation member 700.

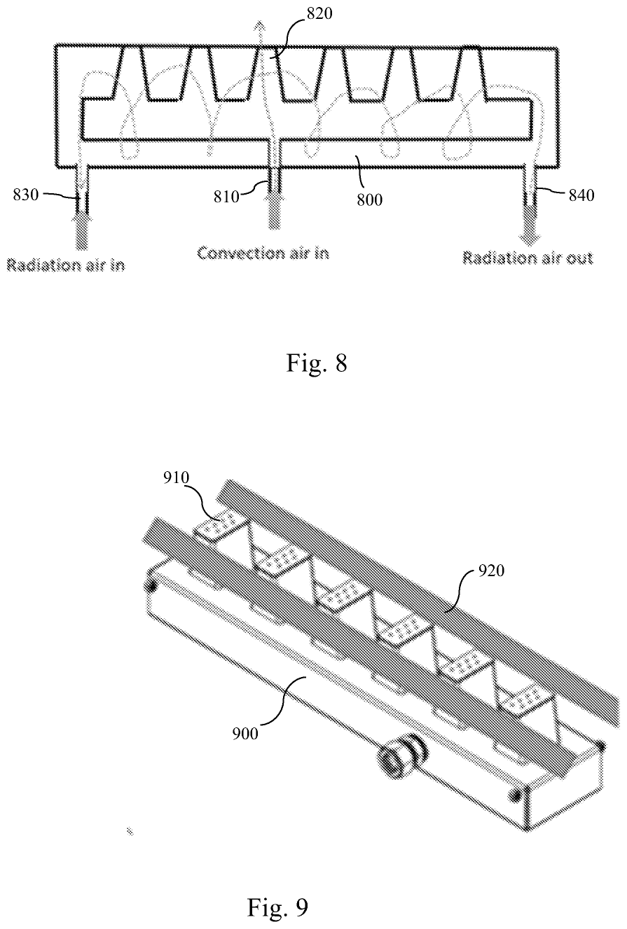

Alternatively, a combination dual mode cooling member can be provided in a CCA. For example, as shown in FIG. 8, the combination member 800 can be configured to provide convection and/or radiation cooling at different times or at different locations of the combination member 800. As an air box, the combination member 800 can include a nozzle or outlet 820 that directs air onto the glass ribbon at the precise location where increased cooling is required. If less aggressive cooling is required, the combination member 800 can be switched by way of a valve (manual or electro-mechanical) to close the nozzle 820 to a radiation cooling mode.

FIG. 8 shows that the combination member 800 can include two air inlets. A convention air inlet 810 provides convection cooling air to the combination member that is forced through a nozzle 820 toward a glass ribbon. Optionally, the combination member 800 can include multiple nozzles that can be individually configured to pass or block air using a corresponding valve (not shown). As shown, a radiation air inlet 830 allows input radiation cooling air to travel through the combination member 800 and exit an outlet 840 at a higher temperature to extract heat from the combination member 800 that has been absorbed due to its proximity to the hotter glass ribbon. Optionally, a coolant other than air can be used to provide the radiant cooling, as discussed above.

For example, for radiation cooling, special cooling mediums could be employed to improve the cooling effectiveness and efficiency, including but not limited to gaseous helium. The thermal conductivity of air is 0.0257 W/(m-K) whereas the same for helium is 0.1513 W/(m-K). Comparable materials are cottonseed oil, 0.173 W/(mK), and water, 0.588 W/(mK). If gaseous helium is used, system fans can be used and cooling will be much more efficient than using air without the problems associated with oil or water cooling. The cooling system could be a sealed loop through radiation air boxes with a backup container of stored helium. Optionally, the cooling medium can be an air-helium mixture, less than 100% pure gaseous helium.

Providing any number of radiation members 700 and combination members 800 can be used to cool the thicker portion of the glass ribbon at a different rate than the thinner portion. Either member 700, 800 can be maintained at a lower temperature than the remainder of the CCA in which it is located and placed at a shorter distance from the surface of the thicker portions of the glass ribbon. Optionally, cooling can be from the top, the bottom, or both sides of the glass ribbon.

In another embodiment, an air box can provide heating in addition to cooling. The heating feature could be used to reduce the temperature gradient caused at the thick-to-thin interface on the glass ribbon. In one configuration, shown in FIG. 9, two strip heaters 920 can located to extend along two sides of an air nozzle array 910 on an air box 900. The strip heaters 920 radiate heat to the glass ribbon to retain heat or even re-heat precise locations where the thick-to-thin interface exists to reduce stress in the glass ribbon at this interface.

The heaters can include a sectional heating zone to heat the thinner and/or thicker portions at different rates. The sectional heaters can be used in conjunction with the moveable air boxes to provide precisely controlled heat treatment for the glass ribbon. Alternatively, a CCA module can be maintained at a temperature above the temperature of the thinner portions of the ribbon to heat such sections while local cooling boxes cool the thicker portion.

Any type of cooling (convention, radiation, and combination), heating, or heating/cooling air box can be provided such that each can be independently moveable and positioned to align with any portion of the glass ribbon. Any air box can be placed together in the center of the glass ribbon to cover a wider thicker portion or they can be spread apart toward the edges of the glass ribbon to cover a narrower edge-strip configuration. Any of the air boxes can be independently located above, below, to the side, or parked out of the way when not in use with respect to the glass ribbon and be placed in position manually or by an automated electro-mechanical positioning system. Optionally, any number of positions of any number of air box that heat and/or cool can be located by automation and preprogrammed so that different configurations of processes of glass ribbons can be repeatable.

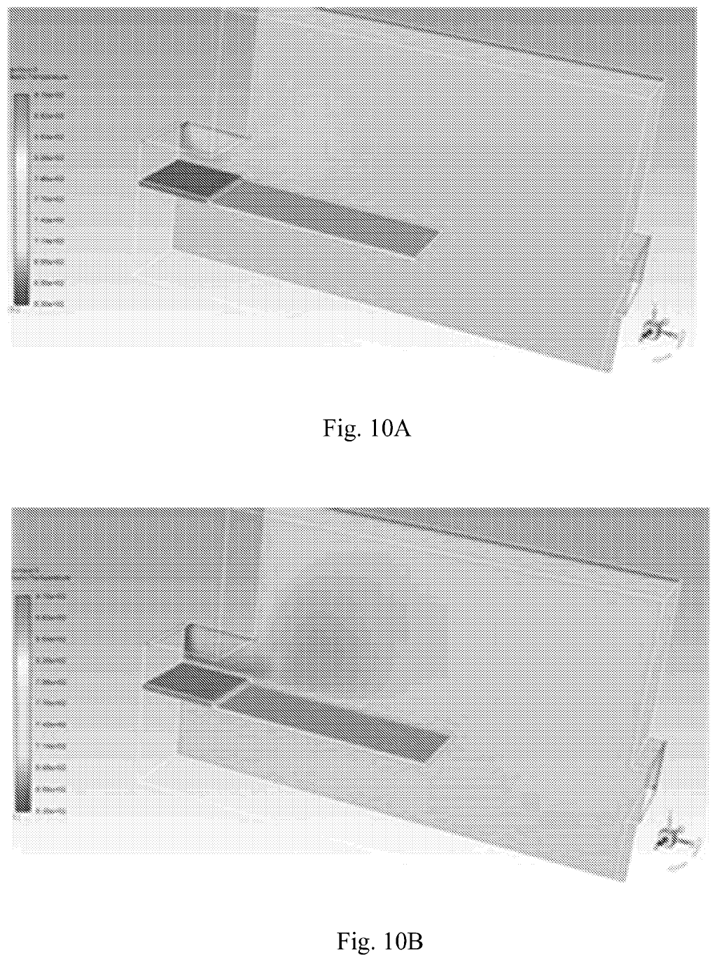

FIGS. 10A and 10B are models showing the effects of air flow from an air box forcing air onto a top side of a glass ribbon. A portion of a glass ribbon including a thicker portion and a thinner portion is shown in a volume of air around the portion of the ribbon. Although not shown, the air box would be located just above and proximate to the thicker portion. The model in 10A shows cooler forced air cools the thicker portion of the glass ribbon. FIG. 10B shows that increased air flow provides additional cooling to the thicker portion.

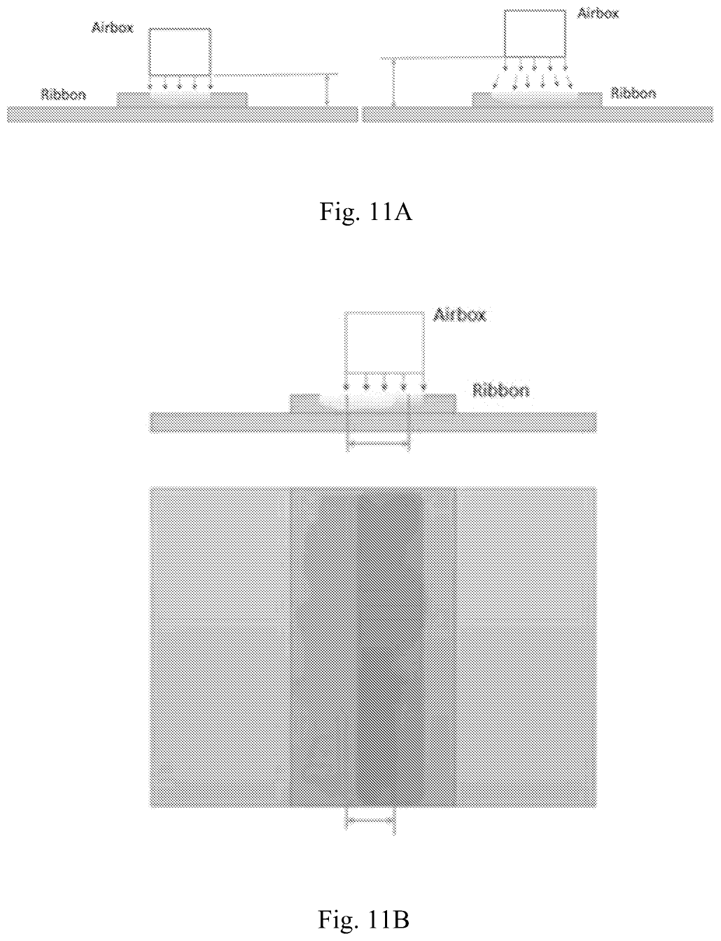

FIGS. 11A and 11B are diagrams representing the cooling effects to a thicker portion of a glass ribbon as the distance from an air box to the glass ribbon changes. A comparison of the left side to the right side of FIG. 11A shows that as the distance from the air box to the thicker portion increases the cooling effects are wider or more dispersed as the forced air spreads out from the air box.

FIG. 11B shows the control logics of aligning the air cooling coldzone and hotzone. The Corning temperature monitor system can measure and analyze where the hotzone (slow heat flux zone on ribbon especially on the strip where usually is thicker) and the coldzone (where near the airbox cooling effects). The distance of center of hotzone and center of coldzone is calculated by the methods Corning developed, the results is employed to automatically adjust the gap so that the hotzone is minimized. The blue rectangular zone is the air cooling zone, which is calculated and predictable due to air cooling controls. The red irregular zone is the nature of temperature distribution measured by a thermal camera or other measurement tools. The control system will calculate the cold zone center and hot zone center line and minimize the distance between those two accordingly.

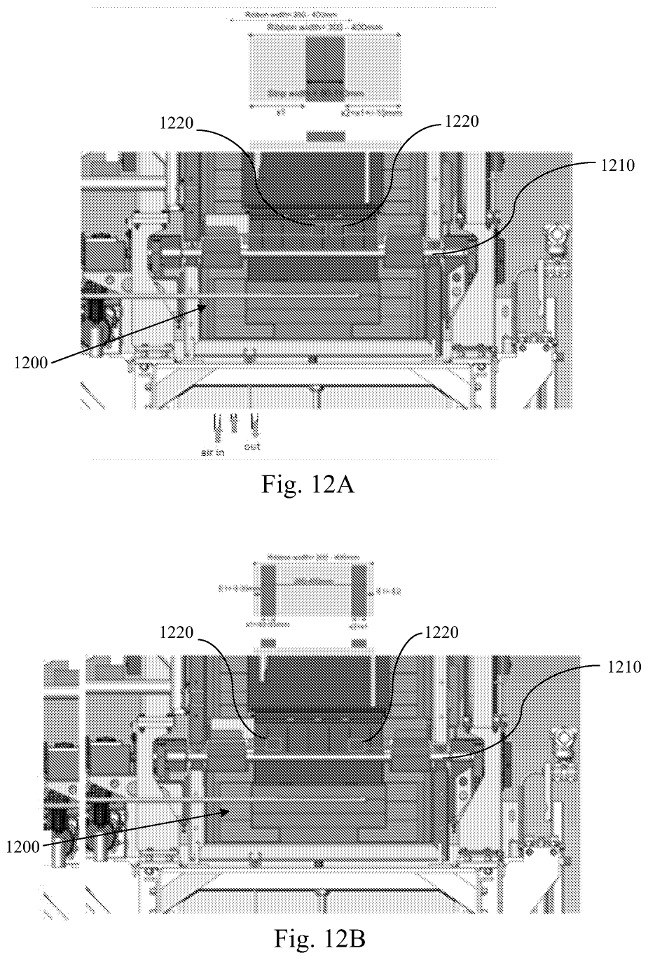

FIGS. 12-16 are cross sectional representations of a CCA tunnel with different configurations and locations of air boxes. The red boxes shown in FIGS. 12-16 represent locations of air boxes that can be of any type used for heating and/or cooling as discussed above. Representations of a configuration of a glass ribbon associated with the CCA tunnel configuration are shown about the CCA tunnel where the darker blue indicates a thicker portion and the lighter blue indicates a thinner portion similar to that shown with respect to FIGS. 1A-1C. Descriptions of like features will not be repeated for brevity.

FIGS. 12A and 12B are cross sectional views of a CCA tunnel 1200 showing a roller 1210 configured to support a traveling glass ribbon riding on the roller 1210. In FIG. 12A, two air boxes 1020 are adjacent to each other above the roller 1210 and located to cool the center of the glass ribbon. A representation of the glass ribbon is provided above the CCA tunnel and is similar to the configuration shown in FIG. 1B. In FIG. 12B, the two cooling boxes 1220 are apart from each other above the roller 1210 and located to cool two outer portions of the glass ribbon. A representation of the glass ribbon is provided above the CCA tunnel and is similar to the configuration shown in FIG. 1C.

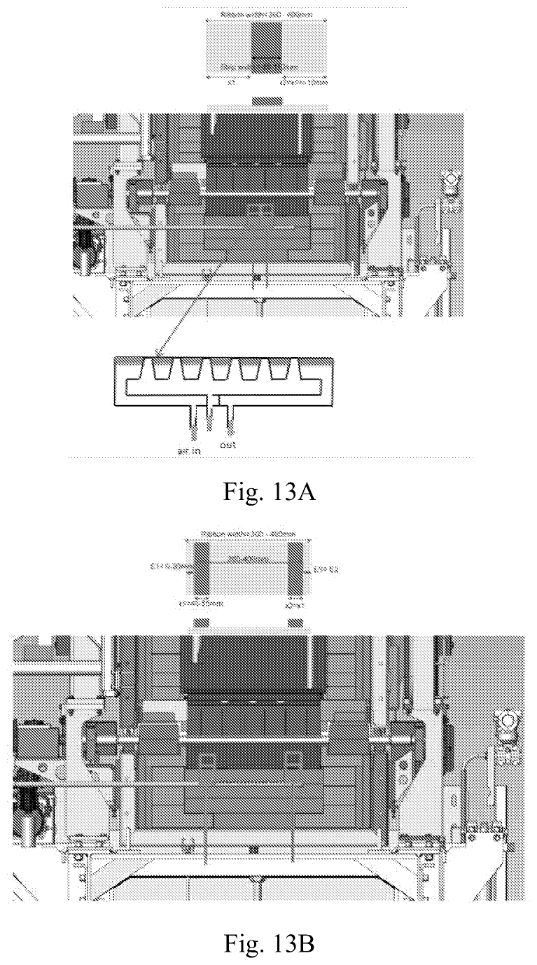

FIGS. 13A and 13B are cross sectional views of a CCA tunnel showing that the air boxes can be located below the glass ribbon and controlled from a bottom portion of the CCA tunnel. FIG. 13A includes an additional representation that shows the air box can be configured like that described with respect to FIG. 8.

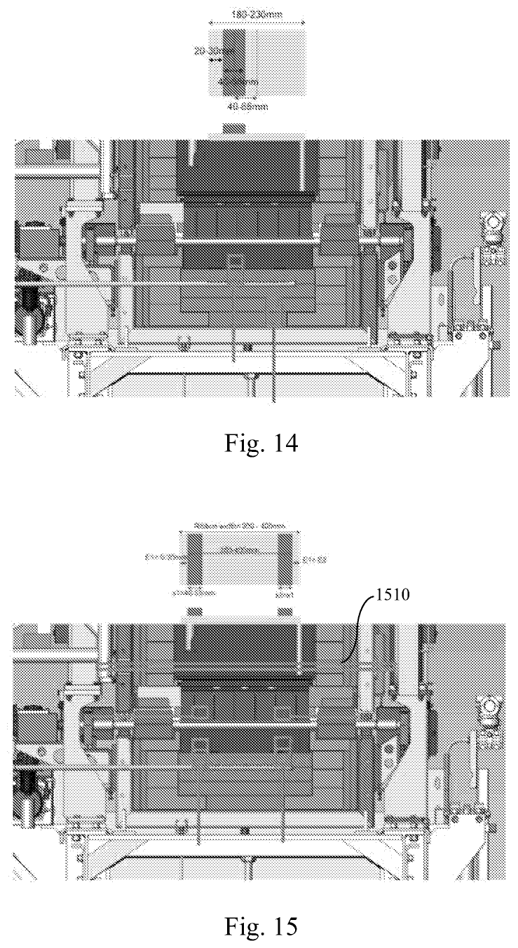

FIG. 14 shows air boxes in a CCA tunnel that can be vertical adjusted. It is possible that the entire width of the CCA tunnel can be filled with air boxes that are rigidly fixed in the cross-machine direction but can be raised and lowered. In such a configuration, an operator can decide which boxes shall blow air and can raise those boxes so that they are at an appropriate distance from the glass ribbon so as to appropriately focus the heating and/or cooling. Air boxes that are not needed can remain at a lower position and be powered off.

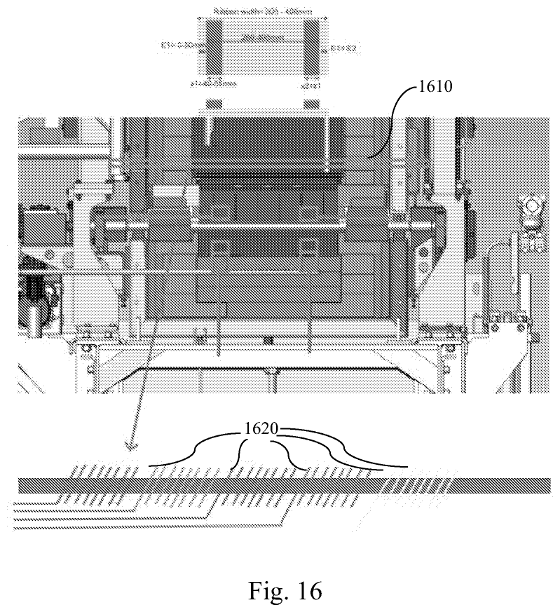

FIG. 15 shows a CCA tunnel with air boxes located both above and below a glass ribbon. FIG. 15 also includes a representation of an additional localized heater 1510. FIG. 16 also shows a CCA tunnel with air boxes located both above and below a glass ribbon and an additional localized heater 1610 similar to that shown in FIG. 15. However, heater 1610 is different in that it includes sectional heaters 1620 represented by the different colored coils to that are each separately controlled to heat the thinner and/or thicker portions of the glass ribbon at different rates. Although five sectional heaters are shown, any number is possible. The sectional heaters 1620 can be used in conjunction with the moveable air boxes to provide precisely controlled heat treatment for the glass ribbon.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1. A glass ribbon processing apparatus to produce a glass ribbon with variable thickness, the apparatus comprising:
a first device that cools a first portion of a width of the glass ribbon at a different rate than a second portion of a width of the glass ribbon, wherein the first portion is thicker than the second portion.

2. The apparatus of claim 1, wherein the first device is located above or below and approximate to the glass ribbon.

3. The apparatus of claim 1, wherein the first device is a heat exchanger that extracts heat from the first portion.

4. The apparatus of claim 1, wherein the first device forces air onto the first portion.

5. The apparatus of claim 1, wherein the first device is configured to extract heat from the first portion and force air onto the first portion.

6. The apparatus of claim 3, wherein the first device includes a valve to adjust the air forced onto the first portion.

7. The apparatus of claim 1, wherein the first device includes a heater.

8. The apparatus of claim 1, further comprising a second device that heats any portion of a width of the glass ribbon.

9. The apparatus of claim 8, wherein the second device heats an interface of the first portion and the second portion.

10. The apparatus of claim 1, wherein the first device is a plurality of first devices that are configured to be positionally adjusted within the apparatus.

11. The apparatus of claim 1, further comprising a sectional heater that includes at least two heating zones to provide heat treatment to the glass ribbon.

12. A method of producing a glass ribbon with variable thickness, the method comprising:
conveying the glass ribbon; and
cooling a first portion of a width of the glass ribbon at a different rate than a second portion of a width of the glass ribbon, wherein the first portion is thicker than the second portion.

13. The method of claim 12, wherein the cooling is provided by a device that is located above or below and approximate to the glass ribbon.

14. The method of claim 12, wherein the cooling is provided by a heat exchanger that extracts heat from the first portion.

15. The method of claim 12, wherein the cooling is from air forced onto the first portion.

16. The method of claim 13, wherein the first device is configured to extract heat from the first portion and force air onto the first portion.

17. The method of claim 13, wherein the first device heats the glass ribbon.

18. The method of claim 12, further comprising heating an interface of the first portion and the second portion.

19. The method of claim 12, further comprising heating the width of the glass ribbon in sections.
